(19) United States
(12) Patent Application Publication
(10) Pub. No.: US 2010/0199357 A1
(43) Pub. Date: Aug. 5, 2010

(54) SECURE HOSTING FOR UNTRUSTED CODE

(75) Inventors: Kristofer D. Hoffman, Sammamish, WA (US); Michael Ammerlaan, Sammamish, WA (US); Matthew M. Swann, Bothell, WA (US); Dale A. Rector, Bothell, WA (US); Hongzhou Ma, Redmond, WA (US); Roger F. Grambihler, Woodinville, WA (US); Shaofeng Zhu, Bellevue, WA (US); William James Griffin, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/363,791

(22) Filed: Feb. 2, 2009

(51) Int. Cl. G06F 21/22

(52) U.S. Cl. 726/27; 726/26

(57) ABSTRACT

Various technologies and techniques are disclosed for increasing security in execution environments. A system is described for handling DLL calls made from untrusted code. An execution environment instantiates a lower trust process when a high trust process determines a need to call untrusted code. When the untrusted code calls a method in an original DLL, the execution environment loads a shim DLL into the lower trust process. The shim DLL has a clone of the method from the original DLL. A method for increasing security when processing calls from untrusted code is described. A shim DLL is created from an original DLL, and is deployed so an execution environment will load the shim DLL instead of the original DLL. When an execution environment receives a call from a caller DLL to the original DLL, the call is routed through the shim DLL. A pluggable validation system is also described.

### BACKGROUND

It has become increasingly popular to allow applications written by one company to call applications that were written by another company. Some applications even combine functionality provided by multiple applications offered by multiple companies.

Whenever functionality of a particular application is exposed to other companies or parties who want to call that application from their own applications, there are increased chances that the third party application will find security holes that allow for it to perform operations that are not otherwise authorized or exposed. In other words, any time untrusted code is allowed to call a trusted DLL, a possibility of a security exploitation exists. Similarly, whenever applications from multiple companies are hosted on the same servers, such as in hosted environments, the same type of security exploitation problem exists.

### SUMMARY

Various technologies and techniques are disclosed for increasing security in execution environments. A system is described for handling DLL calls made from untrusted code. An execution environment instantiates a lower trust process when a high trust process determines a need to call untrusted code. The lower trust process is responsible for running the untrusted code. When the untrusted code makes a call to a method in an original DLL, the execution environment loads a shim DLL into the lower trust process. The shim DLL has a clone of the methods and/or method signatures in the original DLL.

In one implementation, a method for increasing security when processing calls from untrusted code is described. A shim DLL is created from an original DLL. The shim DLL is deployed such that an execution environment will load the shim DLL instead of the original DLL. When the execution environment receives a call from a caller DLL to the original DLL, the call is routed through the shim DLL.

In another implementation, a pluggable validation system for execution environments is also described. A validation request module receives a request to validate whether a call to a DLL from untrusted code running in a lower trust process is authorized. A scanner module receives the request to validate from the validation request module and accesses one or more validation rules to determine if the call is authorized. The validation rules are configurable. An execution module is responsible for executing the call when the scanner module determines the call is authorized.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of routing calls to an original DLL through a lower trust DLL first.

FIG. 2 is a diagrammatic view of a system for executing requests from trusted processes that need to call untrusted code.

FIG. 3 is a process flow diagram for one implementation illustrating the stages involved in generating and using a shim DLL in an execution environment.

FIG. 4 is a diagrammatic view of a system for providing pluggable and extensible validation of one implementation.

FIG. 5 is a process flow diagram for one implementation illustrating the stages involved in validating whether untrusted code is allowed to execute based upon established validation rules.

FIG. 6 is a diagrammatic view of a computer system of one implementation.

### DETAILED DESCRIPTION

The technologies and techniques herein may be described in the general context as a platform for executing code, but the technologies and techniques also serve other purposes in addition to these. In one implementation, one or more of the techniques described herein can be implemented as features within an execution framework such as MICROSOFT®.NET Framework, or from any other type of program or service that is responsible for managing calls between processes and/or DLLs. In another implementation, one or more of the techniques described herein are implemented as features within any type of application that receives and/or manages calls from lower trust processes and/or DLLs.

In order to let untrusted code perform actions with API calls allowed by the runtime environment, untrusted code will typically need to be able to call an API which accesses data, for example, in a database. These APIs may provide some security functions on top of data coming from the database, such as isolation of one customer's data from another customer's data or determining whether the caller has the right to read such data. If there is an elevation of privilege bug that is exploited by the untrusted code, the untrusted code could bypass the APIs in between and directly read and write into the database without permission.

In one implementation, techniques are described for improving security to reduce the chances of such exploitations when processing calls in an execution environment from untrusted code. The term “untrusted code” as used herein is meant to include code that comes from a third party or other source that is making a call to a higher trust DLL or is attempting to perform an operation that is reserved for higher trust DLLs. The term “execution environment” as used herein is meant to include one or more processes that are responsible for receiving and routing calls from one process or DLL to another. The term “DLL” as used herein is meant to include compiled units of code that are contained together in a dynamically linked library, executable, script, or other process that can be called from another process or DLL.

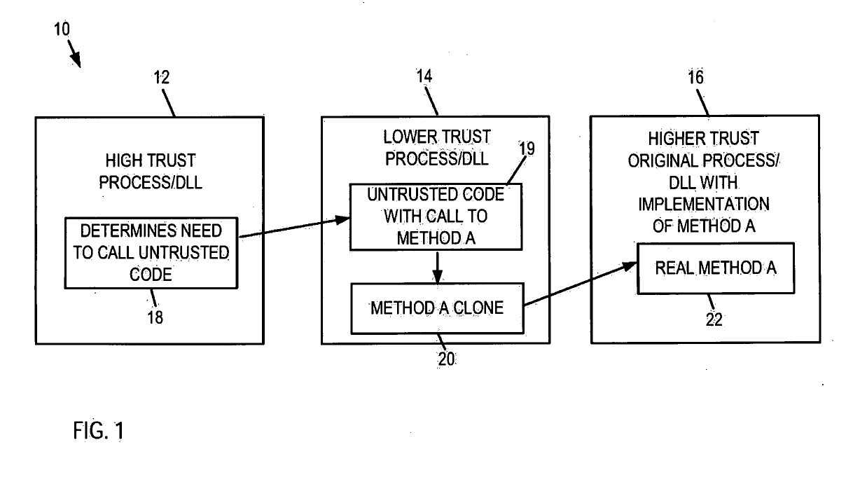

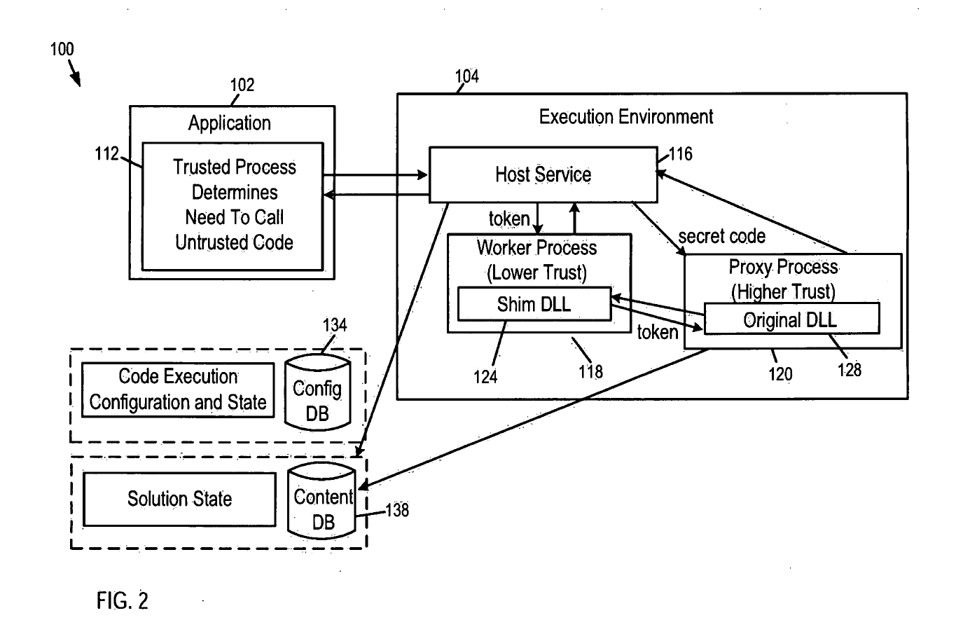

One way to improve security in such situations is by first routing calls from untrusted code that are made to trusted DLLs through a lower trust DLL that has reduced privileges, as described in detail in FIGS. 1-3. In one implementation, additional tokens can be passed between the lower trust DLL and the trusted DLL to further indicate what permissions are authorized. The term “trusted DLL” and “original DLL” as used herein is meant to include a DLL that is fully trusted by the execution environment to perform operations without any harmful intentions. The use of additional tokens to improve security is described in more detail in FIG. 2.

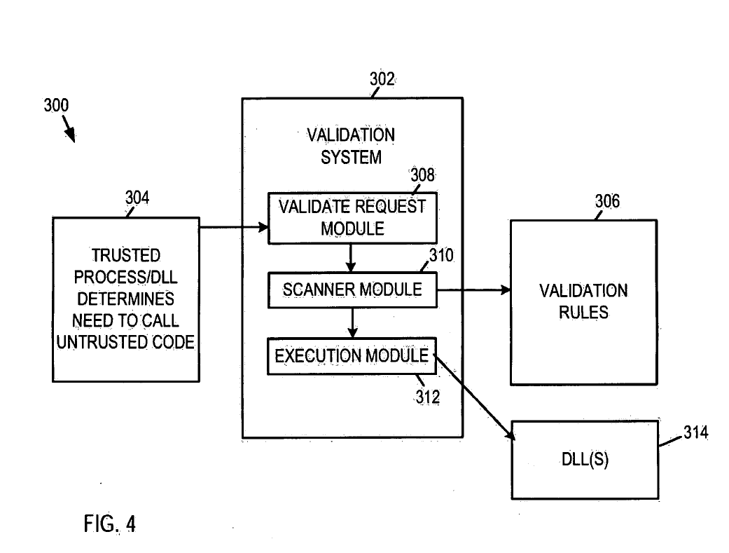

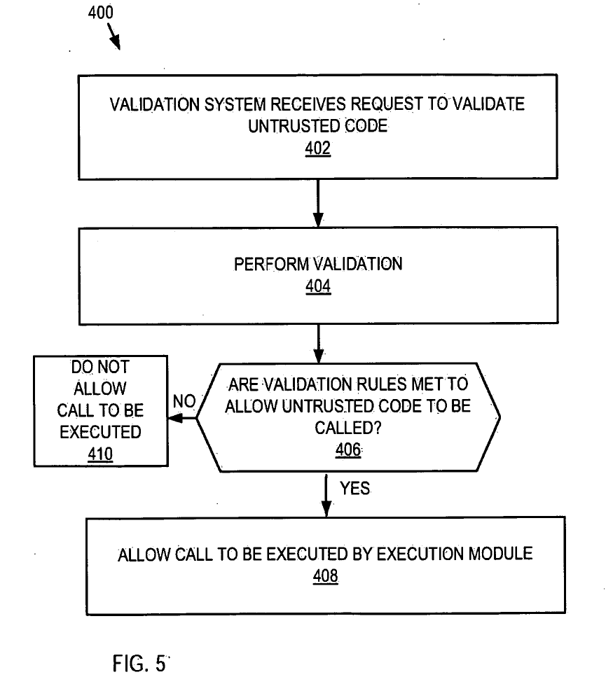

Alternatively or additionally, additional validation can be performed before allowing the call to be routed to the trusted DLL that has full permission. These validation techniques are described in further detail in FIGS. 4 and 5.

FIG. 1 is a diagrammatic view 10 of routing calls to an original DLL through a lower trust DLL first. When a high trust process/DLL 12 determines a need to call untrusted code 18, then a lower trust process 14 is instantiated or obtained. The lower trust process 14 is responsible for loading the untrusted code. Suppose the untrusted code 19 has a call to method A. The call to method A is routed through a clone for method A 20 first. In one implementation, the clone can be an exact duplicate of the code in the original DLL, in which case the original DLL will never need to be called. In another implementation, the clone can be an exact copy of the method signature from the original DLL, but without containing the rest of the code from the original DLL. Thus, the clone for method A 20 is a copy of the real method A 22 or its method signature that is contained within a higher trust original process/DLL 16. In other words, when untrusted code 19 attempts to call the real method A 22, the call first gets routed through the method A clone 20. In one implementation, additional security comes from additional validation that method A clone 20 implements before calling the real method A 22.

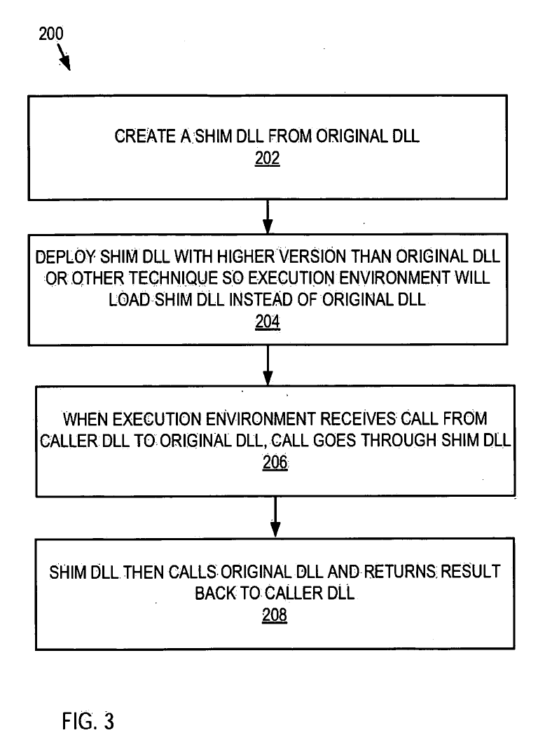

In one implementation, untrusted code 19 is unaware that the method A clone 20 is not the higher trust original process/DLL 16. One technique for accomplishing this is described in further detail in FIG. 3.

FIG. 2 is a diagrammatic view of a system 100 for executing requests from trusted processes that need to call untrusted code. System 100 takes advantage of process-level boundaries in an operating system such that one process is given very low rights (worker process 118), and another process has the correct rights needed to access the database or other functionality (proxy process 120). The term “worker process” as used herein is meant to include a lower trust process. In other words, access rights are basically removed in the lower trust process for database or other essential resources so that a process running untrusted code cannot gain access to them. As incoming calls come in from application 102 (such as from a client browser or desktop application), portions of the call requiring untrusted code to execute are routed to the host service 116. From host service 116, the calls are routed to the worker process 118 (which is the lower trust process).

In one implementation, to help ensure that when a trusted process determines a need to call untrusted code 112 that arbitrary calls cannot be made into the original DLL 128, the secret code and tokens are used. In such an implementation, hosting service 116 shares a secret code with the proxy process 120, such as at the beginning of process startup. The term “secret code” as used herein is meant to include a code that is known by the host service and proxy process, but is not known or obtainable by untrusted code in a lower trust process. The secret code will allow the worker process proxy 120 to calculate whether a token provided by worker process 118 on later calls is a valid token or not. Host service 116 supplies worker process 118 with a token that has been hashed with the secret code that provides context. The token can include one or more constraints, such as on the timeframe, site, and user that the operations can be performed against. When code in the worker process 118 needs to call an original DLL 128 through the shim DLL 124, that request is routed to the proxy process 120 (or a proxy DLL loaded in the proxy process 120) along with the token.

The proxy process 120 (or a proxy DLL loaded in the proxy process 120) validates that the token is actually valid for the time and site specified, and if so, makes the call to the original DLL 128 as requested by the shim DLL 124. The shim DLL 124 looks to the worker process 118 like the original DLL 128 that it made the call to. One implementation for how the shim DLL 124 is made to look like the original DLL 128 is described in further detail in FIG. 3.

Although just one worker process 118 and one proxy process 120 are shown in FIG. 2 for the sake of clarity, it will be appreciated that multiple worker processes and proxy processes could be used. In such an implementation, as user code worker processes (such as 118) are started or stopped, a parallel worker process proxy is also started (such as 120).

In one implementation, system 100 has a configuration database 134 and a content database 138. Configuration database 134 is a data store that contains information for how one or more servers are configured and administered. Content database 138 is a data store that contains user content and customizations to that content. In one implementation, some of the techniques described in FIG. 2 with the worker and proxy processes are used to ensure that unauthorized access cannot be made to configuration database 134 and/or content database 138. In other words, system 100 can help ensure that untrusted code can only read/modify/delete the stored data that the untrusted code is given access to.

In another implementation, code access security technologies are used in the execution environment 104 to further restrict the set of APIs that can be called from untrusted code. Essentially, the worker process 118 with lower trust is run in a code access security group with minimal permissions. For example, worker process 118 can be restricted from calling most APIs that allow it to access the file system, from doing arbitrary database calls, from accessing the network, etc.

In yet another implementation, an additional layer of defense that can be used is to monitor code execution within a process to ensure that unauthorized pieces of code are not loaded, or if those unauthorized components are loaded, that they are loaded with the same minimal rights granted to the untrusted code.

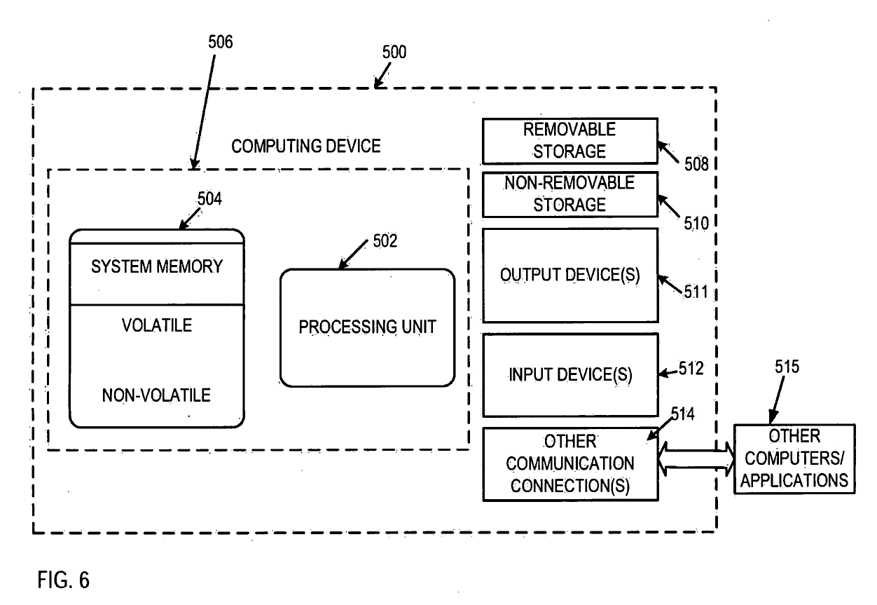

Turning now to FIGS. 3-5, the stages and techniques for implementing one or more implementations of system 100 are described in further detail. In some implementations, the processes of FIG. 3-5 are at least partially implemented in the operating logic of computing device 500 (of FIG. 6).

FIG. 3 is a process flow diagram 200 that illustrates one implementation of the stages involved in generating and using a shim DLL in an execution environment. A shim DLL is created from an original DLL (stage 202). The term “shim DLL” as used herein is meant to include a DLL that is made to look like an original DLL but that has a different set of functionality and/or privileges than the original DLL. In one implementation, the shim DLL can contain copies of all the method signatures in the original DLL. In another implementation, the shim DLL can contain a subset of those method signatures from the original DLL to keep untrusted code from calling dangerous APIs in the original DLL. The shim DLL is then responsible for intercepting calls from the calling processes (such as untrusted code) and routing them to the original DLL. The shim DLL is made by cloning the API signatures and/or code from the original DLL, but loading the shim DLL with lower security permissions. In one implementation, the shim DLL only contains a subset of the API (methods or method signatures, etc.) from the original DLL, so dangerous operations exposed in the original DLL do not have copies in the shim DLL.

As a few non-limiting examples, the database access permissions can be turned off, certain file system operations (such as file system writes) can be restricted, etc. The shim DLL is deployed so that the execution environment will load the shim DLL instead of the original DLL (stage 204). In one implementation, this is accomplished by deploying the shim DLL with a higher version number than the original DLL so that it looks like the original DLL. In other words, the execution environment that is responsible for loading a DLL when it is called will be faced with deciding whether to pass the call to the original DLL or the shim DLL. In this example, since the shim DLL has been deployed with a higher version number than the original DLL, the execution environment will pass any calls to the shim DLL instead of the original DLL because it will think that the shim DLL is just a newer version of the original DLL.

For example, a managed execution environment such as the MICROSOFT® Common Language Runtime would look for the most recent version (which would be the shim DLL in this example) and would thus think that it is loading an updated version of the original DLL. This shim DLL will then work behind the scenes to proxy calls from the untrusted code to a separate process with database or other desired access rights (in original DLL).

This means that when the execution environment receives a call from a caller DLL to the original DLL (whether trusted or not), the call will first go through the shim DLL (stage 206). The shim DLL can then call the original DLL (directly or through a proxy DLL) and return the result back to the caller DLL (stage 208). In this scenario, the caller DLL has no idea that the shim DLL is the one that actually first processed the call instead of the original DLL.

In one implementation, the process described in FIG. 3 makes it possible to take unmodified or slightly modified existing DLLs and make them safer for execution in untrusted environments with minimal intervention. In one implementation, the process described in FIG. 3 also allows untrusted code to be written to run against a well known set of APIs (such as commonly known system DLLs), but yet run with a reduced set of privileges.

FIG. 4 is a diagrammatic view of a system 300 for providing pluggable and extensible validation of one implementation. Customers can provide sets of rules and things to look for in untrusted DLLs which might pose security problems. Validation system 302 has a validation request module 308, a scanner module 310, and an execution module 312. The validation request module 308 is responsible for receiving a request to validate whether a call to a DLL from untrusted code is authorized.

The scanner module 310 is responsible for receiving the request to validate from the validation request module 308 and accessing one or more validation rules 306 to determine if the call is authorized. Validation rules 306 can be stored in a configuration file, database, and/or other locations.

Validation rules 306 are configurable. Validation rules 306 can include operations that are authorized for one or more DLLs and/or operations that are not authorized to be called from untrusted code, etc. These operations can include one or more methods that can and/or cannot be called in particular DLLs from an untrusted process. Alternatively or additionally, these operations can include one or more file system operations that are prohibited by one or more untrusted processes. Yet another non-limiting example of validation rules 306 can include one or more DLLs that have been denied execution or denied access to the application due to a heightened security threat (i.e. the whole DLL can be turned off temporarily or permanently) by simply including a validation rule to indicate that no access to the DLL is allowed.

If the scanner module 310 determines that a particular call it received is authorized, then the execution module 312 is notified that the call is authorized for execution. The execution module 312 is responsible for executing any calls that the scanner module 310 determines are authorized. In one implementation, the execution module 312 can utilize the techniques described in FIGS. 1-3 to use a lower trust DLL to make calls into the higher trust/original DLL. Alternatively or additionally, the execution module 312 can just pass the call directly to the higher trust/original DLL. This validation process will be described in further detail in FIG. 5, which is discussed next.

FIG. 5 is a process flow diagram 400 that illustrates one implementation of the stages involved in validating whether untrusted code is allowed to execute based upon established validation rules. The validation system receives a request to validate whether or not untrusted code is authorized to run (stage 402). Validation is performed on the call to determine whether the call meets the established validation rules (stage 404). If the call does meet the validation rules (decision point 406), then the call is allowed to be executed by the execution module (stage 408) and the results are optionally returned to the process or DLL that made the call. In some implementations, the shim DLL handles and returns results to the caller DLL without involving the original DLL. If the call does not meet the validation rules (decision point 406), then the call is not allowed to be executed (stage 410).

As shown in FIG. 6, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 6 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 6 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A system for handling DLL calls made from untrusted code comprising:
an execution environment that is operable to instantiate a lower trust process when a high trust process determines a need to call untrusted code, the lower trust process being responsible for running the untrusted code; and
when the untrusted code makes a call to a method in an original DLL, the execution environment being further operable to load a shim DLL into the lower trust process, the shim DLL having a clone of the method from the original DLL.

2. The system of claim 1, further comprising:
a host service within the execution environment that is responsible for receiving the call and routing the call to a worker process, the worker process being responsible for loading the shim DLL.

3. The system of claim 2, wherein the host service is further operable to provide a secret code to a proxy process, the proxy process being responsible for loading the original DLL.

4. The system of claim 3, wherein the host service is further operable to provide a token to the worker process, the token being based upon the secret code that was provided to the proxy process, and the token to be used when the call is sent from the shim DLL of the worker process to the original DLL of the proxy process so the original DLL knows whether the call is authorized.

5. The system of claim 1, wherein shim DLL contains only a subset of method signatures from the original DLL.

6. The system of claim 1, further comprising:
a scanner within the execution environment that is operable to access one or more validation rules to determine if the call is authorized.

7. The system of claim 6, wherein the validation rules are configurable.

8. The system of claim 6, wherein the validation rules include a plurality of operations that are not authorized to be called from the lower trust process.

9. A method for increasing security for calls from untrusted code comprising the steps of:
creating a shim DLL from an original DLL;
deploying the shim DLL so that an execution environment will load the shim DLL instead of the original DLL; and
when the execution environment receives a call from a caller DLL to the original DLL, routing the call through the shim DLL.

10. The method of claim 9, further comprising the steps of:
calling the original DLL from the shim DLL.

11. The method of claim 10, further comprising the steps of:
returning results back to the caller DLL.

12. The method of claim 9, wherein the shim DLL has a lower set of privileges than the original DLL.

13. The method of claim 12, wherein the shim DLL does not have any database access rights.

14. The method of claim 12, wherein the shim DLL does not have any file system write permissions.

15. The method of claim 9, wherein the call is received from a lower trust process that is running untrusted code.

16. The method of claim 9, wherein the creating and deploying steps are performed whenever a new version of the original DLL is released into the execution environment.

17. A pluggable validation system for execution environments comprising:
a validation request module that is operable to receive a request to validate whether a call to a DLL from untrusted code is authorized;
a scanner module that is operable to receive the request to validate from the validation request module and access one or more validation rules to determine if the call is authorized, the validation rules being configurable; and
an execution module that is responsible for executing the call when the scanner module determines the call is authorized.

18. The system of claim 17, wherein the validation rules include a plurality of operations that are authorized for the one or more DLLs.

19. The system of claim 18, wherein the plurality of operations include one or more methods that can be called in the one or more DLLs from the untrusted code.

20. The system of claim 18, wherein the plurality of operations include one or more file system operations that are prohibited by the untrusted code.
